(19) United States
(12) Patent Application Publication
(10) Pub. No.: US 2007/0230804 A1
(43) Pub. Date: Oct. 4, 2007

(54) Encoding techniques employing noise-based adaptation

(76) Inventor: Bradley C. Aldrich, Austin, TX (US)

Correspondence Address: KACVINSKY LLC;C/O INTELLEVATE, P.O. BOX 52050, MINNEAPOLIS, MN, 55402, US

(21) Appl. No.: 11/394,929

(22) Filed: Mar. 31, 2006

(51) Int. Cl. G06T 7/40

(52) U.S. Cl. 382/237

(57) ABSTRACT

A system, apparatus, method and article to encode image signals are described. The apparatus may include a noise determination that determines one or more noise characteristics of an image sensor. In addition, the apparatus may include an encoder module that encodes one or more images received from the image sensor in accordance with one or more encoding settings that are based on the one or more noise characteristics. The noise characteristics may be based on various factors, such as dark pixel value statistics. Other embodiments are described and claimed.

### BACKGROUND

It is becoming increasingly common for devices to have video and image processing capabilities. For instance, many portable and fixed devices are now able to capture, display, encode, and decode images for video applications. These capabilities often impose significant loads on a device's resources, such as its processing and memory assets. As a result, many undesirable effects may occur. For example, operations such as video encoding may cause a reduction in the device's headroom resulting in an inability of the device to perform additional tasks. For portable devices, the burden associated with video encoding may also result in a reduction in the device's battery life.

Unfortunately, efforts aimed at mitigating such undesirable effects may lead to other drawbacks. These drawbacks include increased device costs and a reduction in the quality of images delivered by video/image processing operations. Accordingly, techniques are needed to improve the quality of video/image processing operations without imposing significant processing loads or the negative effects associated with these loads.

### BRIEF DESCRIPTION OF THE DRAWINGS

FIG. 1 is a diagram showing an embodiment of an apparatus.

FIG. 2 is a diagram showing an implementation embodiment that may be included within an encoding module.

FIG. 3 is an exemplary view of an image.

FIG. 4 illustrates an embodiment of a logic flow.

FIG. 5 is a view of an exemplary sensor array.

FIG. 6 illustrates an embodiment of a logic flow.

FIGS. 7A and 7B are graphs illustrating pixel profiles and distributions.

FIG. 8 illustrates an embodiment of a system.

### DETAILED DESCRIPTION

Various embodiments may be generally directed to encoding techniques that adapt based on noise characteristics. In one embodiment, for example, a noise determination module determines one or more noise characteristics of an image sensor. Based on this determination, an encoder module selects one or more settings to encode images received from the image sensor. In this manner, encoding settings may be employed that do not compromise the quality of encoded images. Thus, execution and processing efficiency may be attained without compromising encoding performance. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

### I. APPARATUS

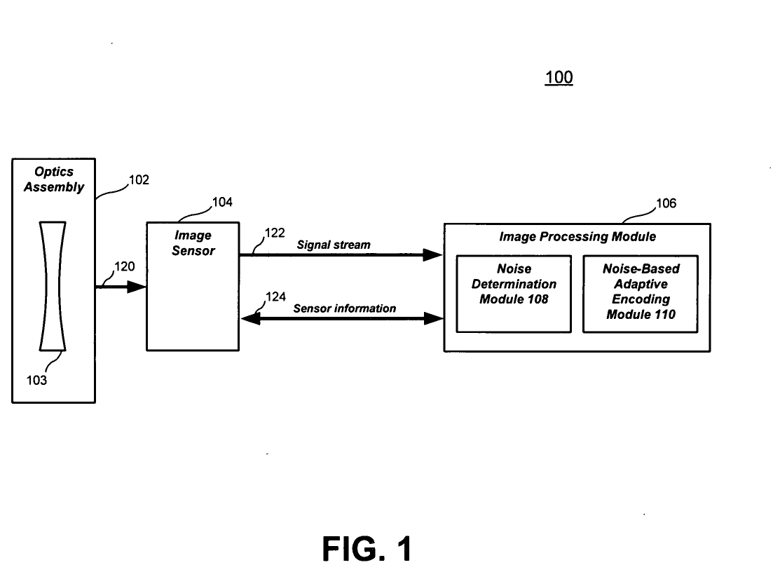

FIG. 1 is a diagram showing an embodiment of an apparatus 100, which may be used to process images, and/or video sequences. For instance, this system may capture, encode, and/or compress image/video signals. Such encoding may employ one or more settings or parameters that are dependent upon noise characteristics associated with the capturing of images.

As shown in FIG. 1, apparatus 100 may include various elements. However, the embodiments are not limited to these elements. In particular, FIG. 1 shows that apparatus 100 may include an optics assembly 102, an image sensor 104, and an image processing module 106. These elements may be implemented in hardware, software, firmware, or in any combination thereof.

Optics assembly 102 may include one or more optical devices (e.g., lenses, mirrors, etc.) to project an image within a field of view onto multiple sensor elements within image sensor 104. For instance, FIG. 1 shows optics assembly 102 having a lens 103. In addition, optics assembly 102 may include mechanism(s) to control the arrangement of these optical device(s) For instance, such mechanisms may control focusing operations, aperture settings, zooming operations, shutter speed, effective focal length, etc. The embodiments, however, are not limited to these examples.

Image sensor 104 may include an array of sensor elements (not shown). These elements may be complementary metal oxide semiconductor (CMOS) sensors, charge coupled devices (CCDs), or other suitable sensor element types. These elements may generate analog intensity signals (e.g., voltages), which correspond to light incident upon the sensor. In addition, image sensor 104 may also include analog-to-digital converter(s) ADC(s) that convert the analog intensity signals into digitally encoded intensity values. The embodiments, however, are not limited to this example.

Thus, image sensor 104 converts light 120 received through optics assembly 102 into pixel values. Each of these pixel values represents a particular light intensity at the corresponding sensor element. Although these pixel values have been described as digital, they may alternatively be analog.

Image sensor 104 may have various adjustable settings. For instance, its sensor elements may have one or more gain settings that quantitatively control the conversion of light into electrical signals. In addition, ADCs of image sensor 104 may have one or more integration times, which control the duration in which sensor element output signals are accumulated. Such settings may be adapted based on environmental factors, such as ambient lighting, etc. In addition, image sensor 104 may have image processing capabilities. Such capabilities may convert RAW pixel data into red, green, and blue (RGB) or YUV data for display and/or compression. Further, such capabilities may provide image scaling and noise reduction features.

FIG. 1 shows that the pixel values generated by image sensor 104 may be arranged into a signal stream 122, which represents one or more images. Thus, signal stream 122 may comprise a sequence of frames or fields having multiple pixel values. Each frame/field (also referred to as an image signal) may correspond to a particular time or time interval. In embodiments, signal stream 122 is digital. Alternatively, signal stream 122 may be analog.

In addition, FIG. 1 shows that image sensor 104 may provide image processing module 106 with sensor information 124. This information may include operational state information (e.g., session initialization) associated with image sensor 104, as well as one or more of its settings. Examples of sensor settings include sensor element gain(s) and ADC integration time(s).

Image processing module 106 may include a noise determination module 108 and a noise-based adaptive encoding module 110. These elements may provide for adaptive noise-based encoding. For instance, noise determination module 108 determines one or more noise characteristics associated with image sensor 104. This determination may be made in various ways. For instance, the determination may involve calculating statistic(s) associated with the intensity values of one or more shielded pixels (also referred to herein as dark pixels). Examples of such statistics include a mean value, a standard deviation, and/or a variance.

Noise determination module 108 may make its determinations upon the occurrence of triggering events. Examples of such events include initialization of a video/image session, and a change in one or more settings of image sensor 104. Exemplary settings include gain and integration time.

Noise-based adaptive encoding module 110 encodes (e.g., compresses) image signals received from the image sensor according to one or more parameters that are based on the determined level of noise. This encoding may employ various compression techniques to take advantage of redundancies (e.g., spatial redundancies and/or temporal redundancies) inherent in signal stream 122. Such techniques may include block matching algorithms, which are described in greater detail below.

Apparatus 100 may be implemented in various devices, such as a handheld apparatus or an embedded system. Examples of such devices include mobile wireless phones, Voice Over IP (VoiP) phones, personal computers (PCs), personal digital assistants (PDAs), and digital cameras. In addition, this system may also be implemented in land line based video phones employing standard public switched telephone network (PSTN) phone lines, integrated digital services network (ISDN) phone lines, and/or packet networks (e.g., local area networks (LANs), the Internet, etc.).

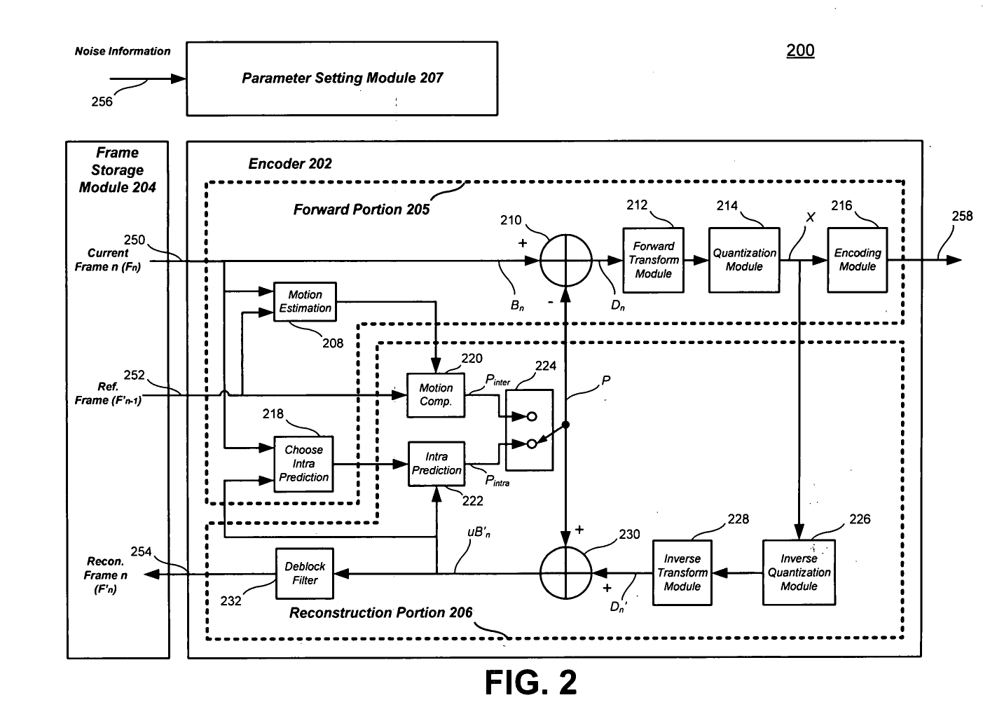

FIG. 2 shows an exemplary implementation 200 that may be included within encoding module 110. This implementation may include various elements, such as an encoder 202, a frame storage module 204, and a parameter setting module 207. However, the embodiments are not limited to these elements.

Encoder 202 may employ a hybrid transform-based motion compensated encoding scheme. The embodiments, however, are not limited to this example. Such encoding schemes may exploit spatial and temporal redundancies to reduce the amount of data needed to represent images. Thus, encoder 202 may comply, for example, with one or more Moving Pictures Expert Group (MPEG) standards, such as MPEG-2 and MPEG-4. Also, encoder 202 may comply with one or more standards established by the International Telecommunications Union (ITU) Telecommunication Standardization Sector (ITU-T). Examples of such standards include H.261, H.263, and H.264.

FIG. 2 shows that encoder 202 includes a forward portion 205 and a reconstruction portion 206. Forward portion 205 receives uncompressed image information and outputs this information in encoded (e.g., compressed) form. However, forward portion 205 relies on reconstruction portion 206 to provide predictive information that is employed for encoding.

Frame storage module 204 stores image signals, such as frames. These frames may be received, for example, from an image sensor, such as image sensor 104. Additionally, frame storage module 204 stores reconstructed frames received from encoder 202. Accordingly, frame storage module 204 may include a storage medium, such as memory. Examples of storage media are provided below.

Parameter setting module 207 may set one or more parameters of encoder 202 based on noise information 256 that it may receive, for example, from noise determination module 108. Accordingly, noise information 256 may be associated with an image sensor. Module 207 may set various parameters based on this information. Examples of settings include thresholds, such as zero motion detection thresholds used in motion estimation algorithms.

Referring again to encoder 202, FIG. 2 shows that its forward portion 205 may include a motion estimation module 208, a combining (e.g., difference) node 210, a forward transform module 212, a quantization module 214, an encoding module 216, and a choose intra prediction module 218. Also, FIG. 2 shows that reconstruction portion 206 may include a motion compensation module 220, an intra prediction module 222, a routing module 224, an inverse quantization module 226, an inverse transform module 228, a combining (e.g., summation) node 230, and an in-loop deblocking filter 232.

FIG. 2 shows that frame storage module 204 presents a current frame 250 (also shown as Fₙ) to forward portion 205. In addition, frame storage module 204 presents forward portion 205 with a reference frame 252 (also shown in FIG. 2 as F′ₙ₋₁₉) However, more than one reference frame may alternatively be presented. Encoder 202 processes these frames in units of macroblocks, such as areas of 16×16 images pixels (However, for inter prediction encoding reference frames may be processed in the form of variable size regions). For instance, FIG. 2 shows a macroblock Bₙ corresponding to current frame Fₙ.

Encoder 202 may encode each of these blocks in an intra-prediction mode or an inter-prediction mode. Each of these modes employs a prediction block, which is shown as P in FIG. 2. Also, for each of these modes, generation of prediction block P is based on a reconstructed frame that is used as a reference.

In intra-prediction mode, module 222 forms prediction block Pᵢₙₜᵣₐ from samples in the current frame n that have been previously encoded, decoded and reconstructed. These samples are shown in FIG. 2 as uF′ₙ. Intra-prediction may be performed according to various modes. Accordingly, module 218 selects one of these modes for each block within Fₙ, Based on this selection, intra-prediction module 222 generates prediction block Pᵢₙₜᵣₐ.

In inter-prediction mode, module 220 forms prediction block Pᵢₙₜₑᵣ by applying motion-compensated prediction techniques from one or more reference frame(s). For example, FIG. 2 shows a reference frame 252, which is the previously encoded and reconstructed frame F′ₙ₋₁. However, two or more encoded and reconstructed frames may be employed as reference frames.

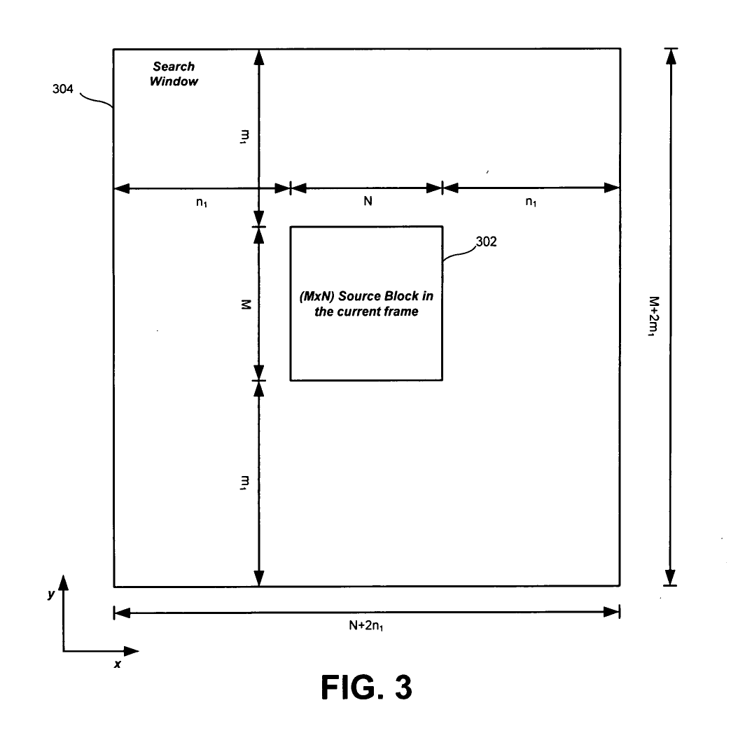

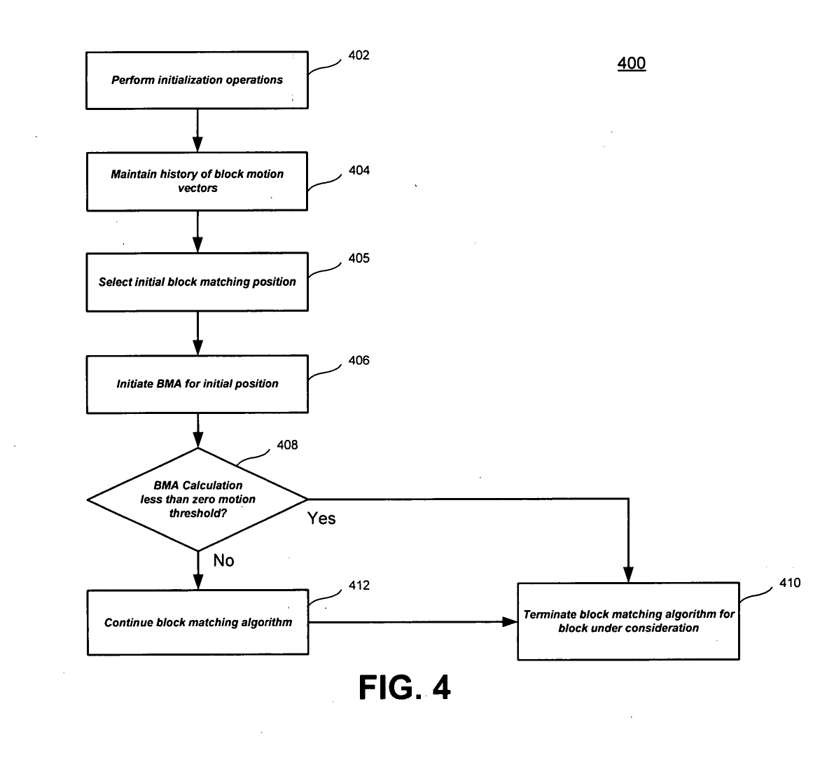

Inter-prediction mode employs motion estimation module 208 and motion compensation module 220. Motion estimation module 208 estimates motion vectors for one or more blocks within current frame Fₙ. These motion vectors are based on corresponding blocks within reference frame F′ₙ₋₁. One approach to motion estimation involves the employment of block matching algorithms. Examples of such algorithms are described below with reference to FIGS. 3 and 4.

For each block within frame Fₙ, motion compensation module 220 produces a prediction block Pᵢₙₜₑᵣ based on the corresponding block within the reference frame. This corresponding block is determined from a motion vector estimated by motion estimation module 208.

As shown in FIG. 2, routing module 224 selects either Pᵢₙₜₑᵣ or Pᵢₙₜᵣₐ as prediction block P. This selection may be based on characteristics of frame Fₙ and one or more other frames. In turn, combining node 210 computes a difference between current macroblock Bₙ (which is within current frame Fₙ) and prediction macroblock P. This produces a residual or difference macroblock Dₙ. Forward transform module 212 transforms Dₙ (using, for example a 4×4 block transform) into a set of transform coefficients. In turn, these coefficients are quantized by quantization module 214 into quantized coefficients X. These quantized coefficients are sent to encoding module 216, which may re-order and entropy encode them.

As a result, encoding module 216 outputs a compressed information stream 258 for macroblock Bₙ. This stream may include the encoded coefficients as well as side information for decoding the macroblock. Examples of such side information may include macroblock prediction mode, quantizer step size, motion vector information describing how the macroblock was motion-compensated, etc. Stream 258 may be processed in various ways. For instance, information stream 258 may be transmitted to a remote device, and/or stored in a storage medium.

As described above, reconstruction portion 206 may include motion compensation module 220, intra prediction module 222, routing module 224, inverse quantization module 226, inverse transform module 228, combining node 230, and deblocking filter 232.

Inverse quantization module 226 receives quantized macroblock coefficients X from quantization module 214 and rescales them. These rescaled coefficients are sent to inverse transform module 228, which performs an inverse transform (e.g., an inverse 4×4 block transform) on the coefficients to obtain a difference macroblock Dₙ′. Dₙ′ may not be identical to original difference macroblock Dₙ. This is because of distortion introduced by quantization module 214.

FIG. 2 shows that difference macroblock Dₙ′ is combined (e.g., summed) with prediction macroblock P to produce a reconstructed macroblock uB′ₙ. This reconstructed macroblock is a distorted version of the original macroblock. To reduce this distortion, deblocking filter 232 is applied to the original macroblock. Also, deblocking filter 232 reconstructs macroblocks into a reconstructed frame 254 (also shown as F′ₙ).

As described above with reference to FIG. 2, image compression techniques may employ motion estimation and compensation. One motion estimation approach involves block matching algorithms (BMAs) that compare equally sized image data blocks contained within two images captured at different times.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality described herein may be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

### II. BLOCK MATCHING ALGORITHMS

As described above, the implementation of FIG. 2 may employ block matching algorithms (BMAs) to estimate motion. These algorithms are directed at generating a motion vector, (MVx,MVy), which estimates the horizontal and vertical displacement of a block from one image to another. The range of a BMA motion vector is constrained by the size of a search window that is employed.

FIG. 3 is a diagram showing an exemplary source block 302 for a current frame (or current image). Source block 302 is within a corresponding search window 304. Comparisons may be made between block 302 and equally sized blocks of a previous image having a displacement from block 302 that is within search window 304.

In FIG. 3, width and height are measured in directions along x and y axes, respectively. Accordingly, FIG. 3 shows source block 302 having a width of N columns and a height of M rows. Further, FIG. 3 shows search window 304 having a width of N+2n₁ columns and a height of M+2m₁ rows.

The number of elements (or pixels) within a block, the metric used for block comparisons, number of comparisons required for each block, and the displacement search pattern are examples of factors that define a cost associated with motion estimation. For instance, the cost may increase as values of these factors increase. This may be represented in the form of a cost function.

The Sum-of-Absolute-Differences (SAD) has gained wide spread adoption as a basis (or metric) for determining motion vectors. This is due to its simplicity and straightforward implementation. For current block 302, the SAD may be calculated as expressed below in Equation (1).

$$SAD ( dx , dy ) = {\sum }_{n = dx}^{dx + N - 1} {\sum }_{m = dy}^{dy + M - 1} \vert {I}_{curr} x ( m , n ) - {I}_{prev} ( m + dx , n + dy ) \vert \qquad ( 1 )$$

In Equation (1): dx and dy represent a displacement between the current block and a previous block-in the x and y directions, respectively; I_{curr}(x,y) represents an element value of the current image or frame at position x, y; and Iₚᵣₑᵥ(x,y) represents an element value of a previous image or frame at position x, y.

Accordingly, the SAD of Equation (1) provides a set of values for a particular block. In particular, Equation (1) shows that the SAD is a function of displacements dx and dy. As expressed above, this block has a size of N columns by M rows.

From this, a motion vector, (MVx, MVy), may be calculated according to Equation (2), below.
(MVx,MVy)=min_{((dx,dy)εR}_{²}SAD(dx,dy) (2)

As expressed in Equation (2), the motion vector for a particular block represents a displacement within a region, R² that yields a minimum SAD value. Thus, 92 represents a search window (e.g., a set of displacements, or dx, dy pairings) in which the SAD is evaluated.

Performing an exhaustive search throughout an entire region or search window involves evaluating each column and row displacement within the window. For instance, the number of operations for a search throughout the search window of FIG. 3 is determined by the range of +/−n₁ columns and +/−m₁ rows. Thus, the total number of absolute difference and summation operations involved in calculating such a SAD is expressed below in Equation (3).
C_{FullSearch}=(2n₁+1)×(2m₁+1)×(M×N) (3)

To conserve processing resources and/or energy, a full search is rarely employed for typical image sequences (video signals). Instead, reduced searching (or subsampling) of a search window is typically performed, as it often yields acceptable quality. Such subsampling approaches are referred to as fast search algorithms. In fast search algorithms, a fixed number of block SADs are typically calculated.

FIG. 4 illustrates a logic flow 400, which may be used to estimate motion for blocks within an image. For purposes of clarity, this flow estimates motion for a single block, which is referred to herein as the block under consideration.

At a block 402, initialization operations are performed. This may comprise setting initial algorithm parameters and values. For instance, block 402 may determine an initial block under consideration.

At a block 404, a history of block motion vectors is maintained or stored. In particular, a history is generated for each of the blocks in an image. If a variable block size scheme is used, block 404 updates the block size and previous position each time a temporal compression sequence is performed.

At a block 405 an initial block matching displacement or position is selected. This initial position may be the zero motion position. However, this position may alternatively be one that seems most likely to produce a best match. Such a position may be determined, for example, from the motion vector history information maintained at block 404.

A block 406 initiates a block matching algorithm (BMA) for the block under consideration. This initiation may comprise performing a block matching calculation, such as an SAD, for the initial position or displacement selected at block 405. At a block 408, it is determined whether the calculation is less than a zero motion threshold value, indicating no motion for this block between successive frames. If so, then the flow proceeds to block 410.

Block 410 terminates the BMA for the block under consideration. Thus, at block 410, the initial displacement (e.g., zero displacement) becomes the estimated motion vector for the block under consideration. Thus, an entire search sequence, which would require multiple block comparisons, may be avoided through employment of the threshold at block 408.

However, if block 408 determines that the SAD is greater than the zero motion threshold, then operation proceeds to a block 412. At this block, the BMA continues. This may comprise searching over a plurality of displacements to generate a motion vector. For example, this may comprise a complete search. However, this may alternatively comprise performing a fast search algorithm. Such algorithms employ one or more early exit techniques, each evaluating an exit threshold for a particular calculation (e.g., a block SAD). Such thresholds may allow excessive computations to be avoided if they are unlikely to generate a match upon completion.

Upon completion of this search, operation proceeds to block 410, where this motion vector becomes the estimated motion vector for the block under consideration.

The example of FIG. 4 illustrates the use of a zero motion threshold. Effective selection of this threshold causes search routines to exit in homogenous regions of a scene. This results in significant performance improvements. In contrast, when this threshold is chosen poorly, both performance and image quality are impacted. Thus, through efficient zero motion vector detection, there is great potential in reducing the cost of motion estimation for video encoding. An exemplary approach adjusts the zero motion threshold based on image sensor noise. This approach is described in greater detail below.

### III. NOISE-BASED ADAPTATION

Systems, such as the system of FIG. 1, may include CMOS image sensor elements. Such elements collect photons incident upon a scene. This collection results in intensity values for each of a plurality of pixel elements. In such a device, several sources of noise may act to degrade the signal to noise ratio (SNR) of these pixel values.

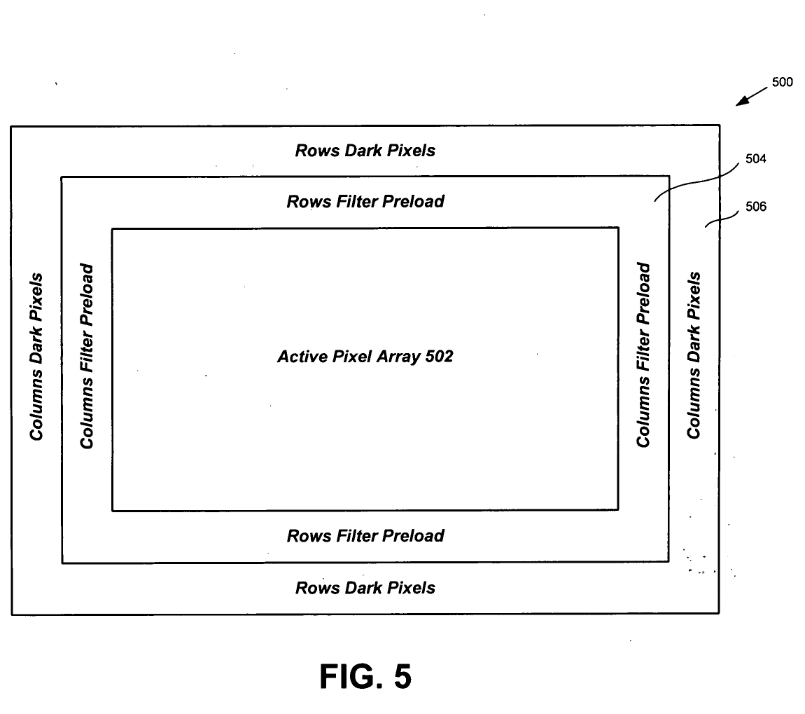

As described above with reference to FIG. 1, image sensor 104 may include an array of pixel elements. One embodiment of such an array is shown in FIG. 5. In particular, FIG. 5 provides a view of an image sensor array 500. This array includes an active pixel region 502, a preload pixel region 504, and a dark pixel region 506. Array 500 may comprise various arrangements of elements. For instance, elements may be arranged in a pattern of rows and columns. However, alternate arrangements, such as axial and spiral patterns, may be employed.

Image sensor array 500 may be an Ultra eXtended Graphic Array (UXGA) having 1620 columns and 1220 rows. As such, active pixel region 502 may have 1600 columns and 1200 rows, preload pixel region 504 may surround region 502 with 3 unshielded rows and columns, and dark pixel region 506 may surround region 504 with 7 shielded rows and columns.

Active pixel region 502 operates as an image capture target. This region includes pixels that are responsive to light. Preload pixel region 504 may include unshielded pixels that are referred to as “pre-filter” pixels. Such pixels may be used for various initialization and image processing operations.

Dark pixel region 506 may include pixels that are shielded from light by, for example, a metal layer. Thus, these pixels (also referred to as reference dark pixels) may be utilized as a reference for determining image sensor noise characteristics.

When a CMOS sensor image array is exposed to light from a scene image, photons hit the image array. As a result, a charge is generated at each CMOS sensor in the array. A portion of each charge is proportional to the photon rate from the scene image.

However, in addition to the charges attributed to image photons, several sources of noise may act to degrade the signal to noise ratio (SNR) associated with these charges. Accordingly, a portion of each charge may be attributed to process inaccuracies that are manifested as various types of noise. These types may include shot noise, fixed pattern noise, analog-to-digital converter (ADC) noise, as well as other on-chip and off-chip noise sources in the image generated by such CMOS sensors. Such noise degrades the quality of sensed images. Such noise contributions can be decomposed, as expressed below in Equation (4).

$$〈 {σ}_{SYS} 〉 = \sqrt{〈 {σ}_{SHOT}^{2} 〉 + 〈 {σ}_{DFPN}^{2} 〉 + 〈 {σ}_{RESET}^{2} 〉 + 〈 {σ}_{ON \text{-} CHIP}^{2} 〉 + 〈 {σ}_{OFF \text{-} CHIP}^{2} 〉 + 〈 {σ}_{ADC}^{2} 〉} \qquad ( 4 )$$

In Equation (4), <σᵢ²> represents noise variance and <σᵢ> represents standard deviation. Thus, based on the above, noise associated with the system may be measured by reading values of dark (i.e. shielded) pixels from a sensor array, such as pixels in dark pixel region 506, and calculating the mean and standard deviation.

This may include storing such dark pixels values in an array, calculating a mean pixel value, X̅ according to Equation (5), and then calculating a pixel value standard deviation, <σ_{SYS}> according to Equation (6).

$$\begin{matrix}\overline{X} = \frac{{\sum }_{i = 0}^{N - 1} Dark\_Pixel \_Array [ i ]}{N} & ( 5 ) \\ 〈 {σ}_{SYS} 〉 = \sqrt{\frac{{\sum }_{i = 0}^{N - 1} [ Dark\_Pixel \_Array [ i ] - \overline{X} ]}{N - 1}} & ( 6 )\end{matrix}$$

During operation (e.g., during video sessions), an image sensor's exposure parameters may change as changes in the environment and scene content vary. Examples of such parameters include sensor gain and sensor integration time (also referred to as exposure integration time). With such changes, the sensor's noise floor may increase or decrease.

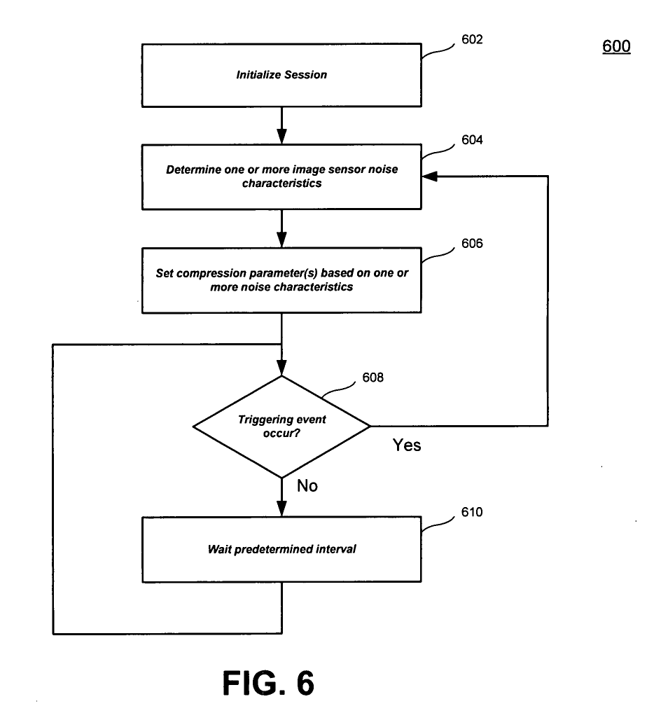

FIG. 6 is diagram showing a logic flow 600. This flow includes a block 602, at which a session is initialized. This may include, for example, initiating a video session, and establishing initial settings for an image sensor (e.g., a CMOS image sensor). Examples of such settings include gain and/or integration time. Such initial settings may be established through an exposure control algorithm. With reference to the embodiment of FIG. 1, exposure control algorithms may be performed by image processing module 106. However, such control may alternatively or additionally be performed by image sensor 104. For instance, image sensor 104 may perform automatic exposure control (AEC)

At a block 604, one or more noise characteristics of the image sensor are determined. This may comprise reading dark pixels and calculating statistics, such as a standard deviation of intensity values for these pixels.

Based on these noise characteristics, one or more compression parameters may be set at a block 606. A zero motion vector threshold is an example of such a parameter. As random sensor noise increases, true scene motion becomes increasingly masked. This can it make impractical to detect low scene motion and may cause many ineffective motion estimation searches to occur.

Therefore, the zero motion threshold may be set to increase and decrease with noise. For example, this threshold may be set to be (or be based on) the standard deviation of dark pixel intensity values. However, parameter(s) other than the zero motion threshold may be additionally or alternatively set.

As indicated by a block 608, determination of noise characteristics and the setting of compression parameters may be performed upon the occurrence of one or more triggering conditions. Triggering events may include a change in image sensor settings, such as gain, and/or exposure integration time.

Block 610 shows that triggering events may be checked for at predetermined intervals, such as after a predetermined number of frames have been captured.

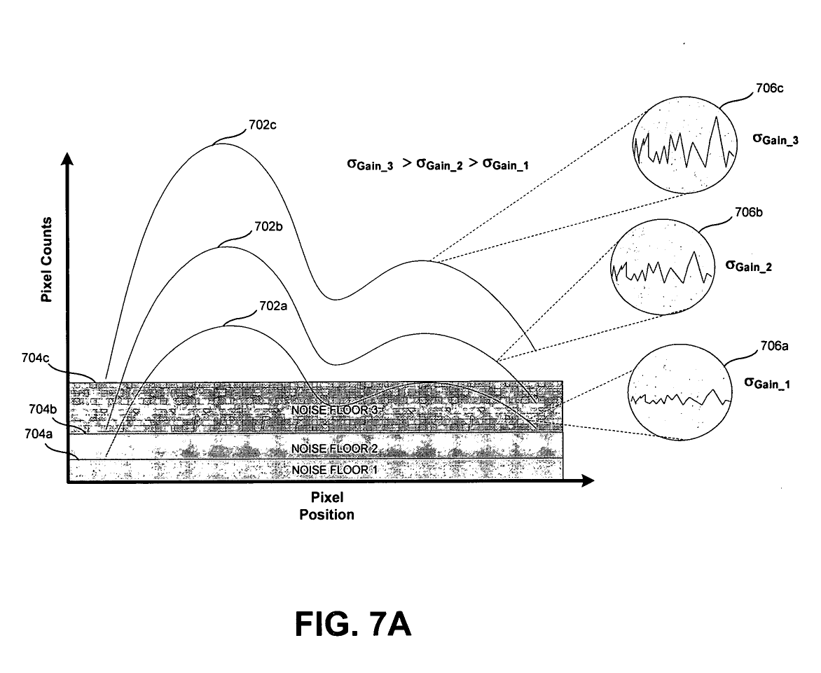

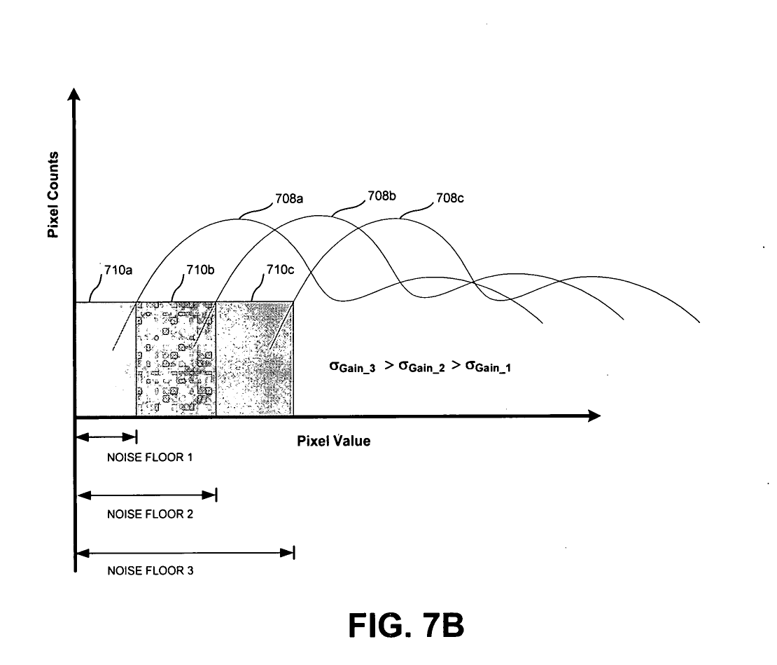

FIG. 7A is a graph illustrating exemplary profiles with respect to different CMOS image sensor settings. These profiles show variations of pixel values across a range of positions. For purposes of clarity, this range of positions is shown as being one-dimensional along the graph's horizontal axis. However, such profiles may be plotted across multi-dimensional ranges.

More particularly, FIG. 7A shows three profiles 702. Each of these profiles corresponds to a particular gain and integration time. Additionally, FIG. 7A shows three noise floors 704 that each correspond to a profile 702. For instance, noise floor 704a corresponds to profile 702a, noise floor 704b corresponds to profile 702b, and noise floor 704c corresponds to profile 702c.

In addition, FIG. 7A shows sample noise waveforms 706. For instance, a noise waveform 706a corresponds to profile 702a, a noise waveform 706b corresponds to profile 702b, and a noise waveform 706c corresponds to profile 702c. Further, noise floors 708 for each of the noise waveforms 706 are shown in FIG. 7A.

FIG. 7B is a graph illustrating pixel value distributions with respect to the CMOS image sensor settings of FIG. 7A. More particularly, FIG. 7B illustrates how pixel value distributions relate to their corresponding noise floors. For instance, FIG. 7B shows a distribution 708a corresponding to a noise floor 710a, a distribution 708b corresponding to a noise floor 710b, and a distribution 708c corresponding to a noise floor 710c. Each of these distribution and noise floor pairings corresponds to a particular image sensor setting (e.g., a gain and integration time).

The information presented in FIGS. 7A and 7B illustrate that with higher gain settings, random sensor noise can mask true scene motion making it impossible to detect low scene motion and may cause many ineffective motion estimation searches to occur. For instance, this may occur in homogenous regions of the image under low light or in devices employing low cost optics).

Thus, significant performance improvements may be obtained through dynamic adaptation of parameters, such as the zero motion vector threshold. Such adaptation may be based on sensor array noise characteristics. Alternatively, such adaptation may be directly based on one or more image sensor parameters, such as gain and/or integration time.

### IV. SYSTEM

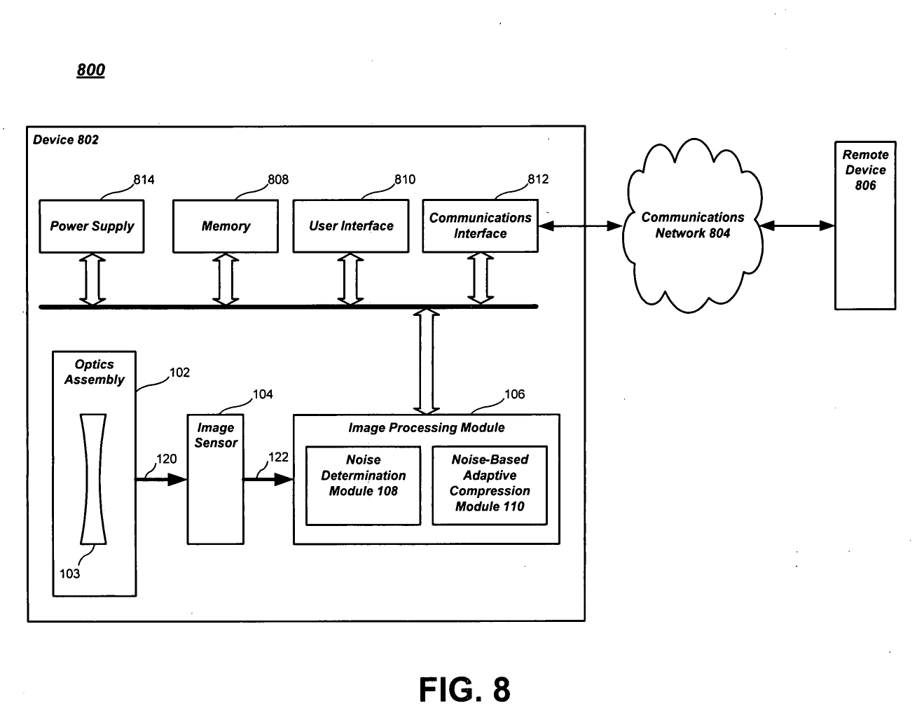

FIG. 8 illustrates an embodiment of a system 800. This system may be suitable for use with one or more embodiments described herein, such as apparatus 100, implementation 200, logic flows 400 and 600, and so forth. Accordingly, system 800 may capture and compress images according to techniques, such as the ones described herein. In addition, system 800 may display images and store corresponding data. Moreover, system 800 may exchange image data with remote devices.

As shown in FIG. 8, system 800 may include a device 802, a communications network 804, and one or more remote devices 806. FIG. 8 shows that device 802 may include the elements of FIG. 1. In addition, device 802 may include a memory 808, a user interface 810, a communications interface 812, and a power supply 814.

Memory 808 may store information in the form of data. For instance, memory 808 may contain images in either encoded or unencoded formats. Alternatively or additionally, memory 808 may store control logic, instructions, and/or software components. These software components include instructions that can be executed by one or more processors. Such instructions may provide functionality of one or more elements in system 800.

Memory 808 may be implemented using any machine-readable or computer-readable media capable of storing data, including both volatile and non-volatile memory. For example, memory 808 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 808 may be included in other elements of system 800. For instance, some or all of memory 808 may be included on a same integrated circuit or chip with as image processing module 106. Alternatively some portion or all of memory 808 may be disposed on an integrated circuit or other medium, for example a hard disk drive, which is external. The embodiments are not limited in this context.

User interface 810 facilitates user interaction with device 802. This interaction may involve the input of information from a user and/or the output of information to a user. Accordingly, user interface 810 may include one or more devices, such as a keypad, a touch screen, a microphone, and/or an audio speaker. In addition, user interface 810 may include a display to output information and/or render images/video processed by device 802. Exemplary displays include liquid crystal displays (LCDs), plasma displays, and video displays.

Communications interface 812 provides for the exchange of information with other devices across one or more communications networks. This information may include image and/or video signals transmitted by device 802. Also, this information may include transmissions received from remote devices, such as requests for image/video transmissions and commands directing the operation of device 802.

Communications interface 812 may provide for wireless or wired communications. For wireless communications, communications interface 812 may include components, such as a transceiver, an antenna, and control logic to perform operations according to one or more communications protocols. Thus, communications interface 812 may communicate across wireless networks according to various protocols. For example, devices 802 and 806 may operate in accordance with various wireless local area network (WLAN) protocols, such as the IEEE 802.11 series of protocols, including the IEEE 802.11a, 802.11b, 802.11e, 802.11 g, 802.11n, and so forth. In another example, these devices may operate in accordance with various wireless metropolitan area network (WMAN) mobile broadband wireless access (MBWA) protocols, such as a protocol from the IEEE 802.16 or 802.20 series of protocols. In another example, these devices may operate in accordance with various wireless personal area networks (WPAN). Such networks include, for example, IEEE 802.16e, Bluetooth, and the like. Also, these devices may operate according to Worldwide Interoperability for Microwave Access (WiMax) protocols, such as ones specified by IEEE 802.16.

Also, these devices may employ wireless cellular protocols in accordance with one or more standards. These cellular standards may comprise, for example, Code Division Multiple Access (CDMA), CDMA 2000, Wideband Code-Division Multiple Access (W-CDMA), Enhanced General Packet Radio Service (GPRS), among other standards. The embodiments, however, are not limited in this context.

For wired communications, communications interface 812 may include components, such as a transceiver and control logic to perform operations according to one or more communications protocols. Examples of such communications protocols include Ethernet (e.g., IEEE 802.3) protocols, integrated services digital network (ISDN) protocols, public switched telephone network (PSTN) protocols, and various cable protocols.

In addition, communications interface 812 may include input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Power supply 814 provides operational power to elements of device 802. Accordingly, power supply 814 may include an interface to an external power source, such as an alternating current (AC) source. Additionally or alternatively, power supply 814 may include a battery. Such a battery may be removable and/or rechargeable. However, the embodiments are not limited to this example.

### V. CONCLUSION

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a noise determination module to determine one or more noise characteristics of an image sensor; and
an encoding module to encode one or more image signals received from the image sensor in accordance with one or more encoding parameter settings, the one or more encoding parameter settings based on the one or more noise characteristics.

2. The apparatus of claim 1, wherein the encoding module comprises:
a motion estimation module to estimate motion between corresponding blocks within one or more images corresponding to the one or more image signals;
wherein the motion estimation module adapts one or more motion estimation parameters based on the one or more noise characteristics.

3. The apparatus of claim 2, wherein the one or more motion estimation parameters includes a zero motion threshold of a block matching algorithm.

4. The apparatus of claim 1, wherein the encoding module is to increase a zero motion vector threshold when the one or more noise characteristics indicates a noise level increase, and is to decrease the zero motion vector threshold when the one or more noise characteristics indicates a noise level decrease.

5. The apparatus of claim 1, wherein the noise determination module is to determine one or more dark pixel value statistics, the one or more noise characteristics based on the one or more dark pixel value statistics.

6. The apparatus of claim 1, further comprising:
an image sensor to provide the one or more image signals;

7. The apparatus of claim 6,
wherein the image sensor comprises a plurality of shielded sensors to generate a plurality of dark pixel values; and
wherein the one or more noise characteristics comprises one or more statistics of the dark pixel values.

8. The apparatus of claim 6, further comprising an optics assembly to project one or more images onto the image sensor, the one or more images corresponding to the one or more image signals.

9. The apparatus of claim 1, further comprising a display to display images corresponding to the one or more image signals.

10. The apparatus of claim 1, further comprising a communications interface to send the one or more encoded image signals to a remote device.

11. An apparatus, comprising:
a noise determination module to determine one or more noise characteristics of an image sensor from a plurality of dark pixel values; and
an encoding module to encode one or more image signals received from the image sensor in accordance with one or more encoding parameter settings, the one or more encoding parameter settings including a zero motion threshold of a block matching algorithm, wherein the zero motion threshold is based on the one or more noise characteristics.

12. A method, comprising:
determining one or more noise characteristics of an image sensor; and
adapting one or more parameter settings of a video encoder based on the one or more noise characteristics.

13. The method of claim 12, wherein determining the one or more noise characteristics comprises determining one or more dark pixel value statistics.

14. The method of claim 12, wherein adapting the one or more parameter settings of the video encoder video comprises adjusting a zero motion vector threshold of a block matching algorithm.

15. The method of claim 14, wherein adjusting the zero motion vector threshold comprises:
increasing the zero motion vector threshold when the one or more noise characteristics indicates a noise level increase; and
decreasing the zero motion vector threshold when the one or more noise characteristics indicates a noise level decrease.

16. The method of claim 12, wherein adapting the one or more parameter settings is performed upon the occurrence of a triggering event, the triggering event including at least one of a change in a gain of the image sensor and a change in an integration time of the image sensor.

17. An article comprising a machine-readable storage medium containing instructions that if executed enable a system to:
determine one or more noise characteristics of an image sensor; and
adapt one or more parameter settings of a video encoder based on the one or more noise characteristics.

18. The article of claim 17, wherein the instructions enabling the system to determine the one or more noise characteristics comprises instructions that if executed enable the system to determine one or more dark pixel value statistics.

19. The article of claim 17, further comprising instructions that if executed enable the system to adjust a zero motion vector threshold of a block matching algorithm based on the one or more noise characteristics.

20. The article of claim 17, further comprising instructions that if executed enable the system to:
receive a video signal; and
encode the video signal with the video encoder.
